(19) United States
(12) Patent Application Publication
(10) Pub. No.: US 2011/0181600 A1
(43) Pub. Date: Jul. 28, 2011

(54) STRUCTURED ARRANGEMENT OF VISUAL ENDPOINTS

(75) Inventors: Stephen M. Danton, Seattle, WA (US); Ramrajprabu Balasubramanian, Renton, WA (US); Puravkumar B. Saraiya, Redmond, WA (US); Pravin R. Indurkar, Sammamish, WA (US); Catherine E. Dumas, Bothell, WA (US)

(73) Assignee: Microsoft Corporation, Redmond, WA (US)

(21) Appl. No.: 12/692,106

(22) Filed: Jan. 22, 2010

(51) Int. Cl. G06T 11/20

(52) U.S. Cl. 345/441

(57) ABSTRACT

The present invention extends to methods, systems, and computer program products for structured arrangement of visual endpoints in diagrams. Generally, endpoint arrangements are consistently used on shapes in a domain (diagram type) based on common information flow characteristics of the domain. In addition, shape specific positioning of endpoints can be based on a shape's unique characteristics. Diagrams are more readable across an organization because diagrams have a more consistent flow structure in the form of endpoints and connections. Diagrams are also easier to construct because endpoints have predictable locations.

### CROSS-REFERENCE TO RELATED APPLICATIONS

Not Applicable.

### BACKGROUND

### Background and Relevant Art

Computer systems and related technology affect many aspects of society. Indeed, the computer system's ability to process information has transformed the way we live and work. Computer systems now commonly perform a host of tasks (e.g., word processing, scheduling, accounting, etc.) that prior to the advent of the computer system were performed manually. More recently, computer systems have been coupled to one another and to other electronic devices to form both wired and wireless computer networks over which the computer systems and other electronic devices can transfer electronic data. Accordingly, the performance of many business related processes are distributed across a number of different computer systems and/or a number of different computing components.

For example, diagramming applications can be used to generate flow charts, organization charts, workflow diagrams, etc. Most diagramming applications include at least a toolbar and a canvas area. A user can pull shapes (e.g., circles, rectangles, squares, diamonds, etc.) from the tool bar to add to the canvas. Shapes can be connected to one another to indicate relationships between the shapes. Users can also rearrange and remove existing shapes and connections within the canvas.

Diagramming applications can utilize a free form canvas or may include automated mechanisms, such as, for example, an auto-layout algorithm, to assist users in appropriately adjusting connections between shapes. On a free form canvas, users have essentially complete control over the organization and spacing of shapes on a canvas. That is, users are free to (re)arrange shapes and connections as they see fit with no restrictions. On the other hand, an auto-layout algorithm can have various layout (e.g., organizational and spacing) constraints that essentially dictate the placement of shapes and connections within a diagram.

However, the arrangement of and connections between shapes are typically limited, at least to some extent, by the end point arrangement on the shapes (i.e., where endpoints are located on the outline of the shape). On many diagram-centric design surfaces, endpoints on a shape are arranged in a generic fashion. For example, endpoints can be equally spaced on regular intervals. Thus, on a rectangle (or square) having four endpoints, one endpoint can be centered on each side of the rectangle.

Unfortunately, generically arranging endpoints fails to provide any guidance to a user as to how their diagrams are to be structured in a specified domain (e.g., an organization chart, a flow diagram, etc.). Further, generically arranging endpoints does not provide an indication of what endpoints are valid for what types of connections and what an individual endpoint represents on a shape. As such, a generic arrangement of endpoints makes it more difficult to both assemble and read diagrams.

### BRIEF SUMMARY

The present invention extends to methods, systems, and computer program products for structured arrangement of visual endpoints in diagrams. An indication is received that a shape of a specified shape type is to be placed in a diagram. The specified shape type is selected from among a plurality of different shape types. The specified shape type indicates particular functionality for inclusion in the diagram. The shape is to include a plurality of endpoints. Each endpoint in the plurality of endpoints indicates a portion of the particular functionality represented by the shape type

It is determined that the diagram is of a specified diagram type. The specified diagram type is selected from among a plurality of different diagram types. A specialized arrangement of the plurality of endpoints is formulated for placement on the shape. The specialized arrangement is based on the shape type and the diagram type. The specialized arrangement is applicable to shapes of the shape type when placed in a diagram of the diagram type. The specialized arrangement defines a position and spacing for each endpoint on the shape relative to other endpoints on the shape. Accordingly, shapes of the shape type are consistently presented in the diagram.

The shape is presented in the diagram at a display device. The plurality of endpoints is placed on the shape in accordance with the positions and spacing defined in the specialized arrangement. As such, presentation of the shape visually reflects the portion of the particular functionality each endpoint represented both in a diagram specific manner and based on the position and spacing of the endpoint relative to other endpoints on the shape.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an example computer architecture that facilitates structured arrangement of visual endpoints in diagrams.

FIG. 2 illustrates a flow chart of an example method for structuring an arrangement of visual endpoints in a diagram.

FIG. 3 illustrates an example of a decision shape that can be included in a diagram.

FIG. 4 illustrates an example of a switch shape that can be included in a diagram.

FIG. 5 illustrates an example of a color switch shape that can be included in a diagram.

### DETAILED DESCRIPTION

The present invention extends to methods, systems, and computer program products for structured arrangement of visual endpoints in diagrams. An indication is received that a shape of a specified shape type is to be placed in a diagram. The specified shape type is selected from among a plurality of different shape types. The specified shape type indicates particular functionality for inclusion in the diagram. The shape is to include a plurality of endpoints. Each endpoint in the plurality of endpoints indicates a portion of the particular functionality represented by the shape type

It is determined that the diagram is of a specified diagram type. The specified diagram type is selected from among a plurality of different diagram types. A specialized arrangement of the plurality of endpoints is formulated for placement on the shape. The specialized arrangement is based on the shape type and the diagram type. The specialized arrangement is applicable to shapes of the shape type when placed in a diagram of the diagram type. The specialized arrangement defines a position and spacing for each endpoint on the shape relative to other endpoints on the shape. Accordingly, shapes of the shape type are consistently presented in the diagram.

The shape is presented in the diagram at a display device. The plurality of endpoints is placed on the shape in accordance with the positions and spacing defined in the specialized arrangement. As such, presentation of the shape visually reflects the portion of the particular functionality each endpoint represented both in a diagram specific manner and based on the position and spacing of the endpoint relative to other endpoints on the shape.

Embodiments of the present invention may comprise or utilize a special purpose or general-purpose computer including computer hardware, such as, for example, one or more processors, system memory, and a display device, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: computer storage media and transmission media.

Computer storage media includes RAM, ROM, EEPROM, CD-ROM or other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry or desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Generally, endpoint arrangements are consistently used on shapes in a domain (diagram type) based on common information flow characteristics of the domain. In addition, shape specific positioning of endpoints can be based on a shape's unique characteristics. Diagrams are more readable across an organization because diagrams have a more consistent flow structure in the form of endpoints and connections. Diagrams are also easier to construct because endpoints have predictable locations.

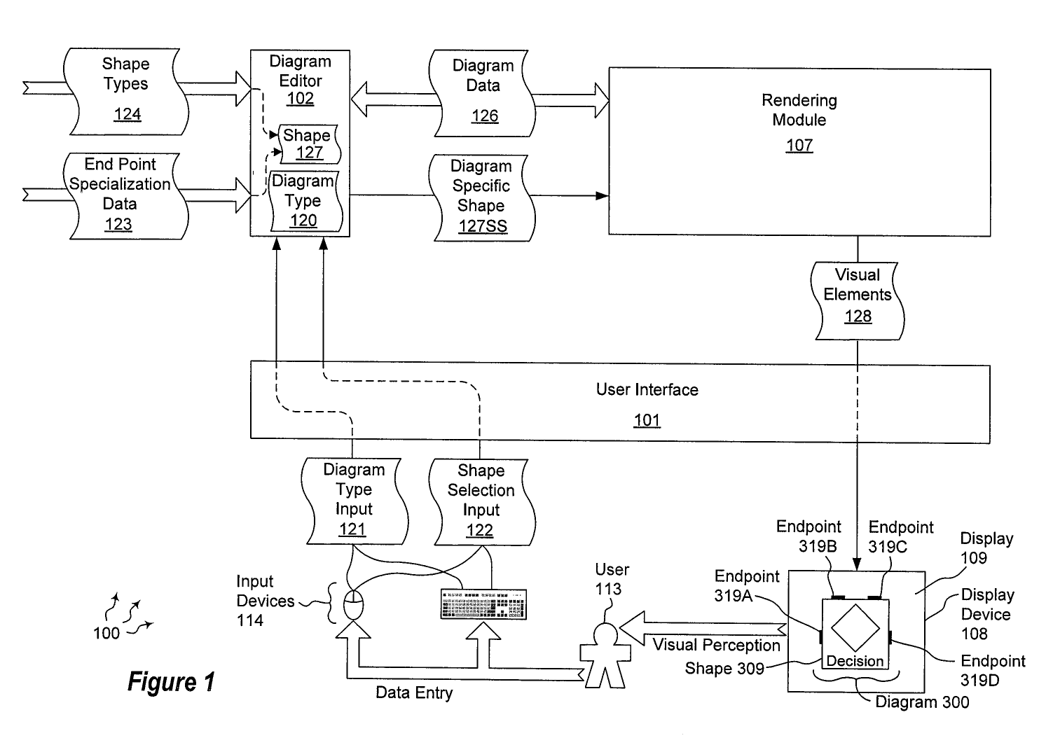

FIG. 1 illustrates an example computer architecture 100 that facilitates structured arrangement of visual endpoints. Referring to FIG. 1, computer architecture 100 includes user-interface 101, diagram editor 102, rendering module 107, display device 108, and input devices 114. Each of the depicted components is connected to one another over (or is part of) a network, such as, for example, a Local Area Network (“LAN”), a Wide Area Network (“WAN”), and even the Internet. Accordingly, each of the depicted components as well as any other connected computer systems and their components, can create message related data and exchange message related data (e.g., Internet Protocol (“IP”) datagrams and other higher layer protocols that utilize IP datagrams, such as, Transmission Control Protocol (“TCP”), Hypertext Transfer Protocol (“HTTP”), Simple Mail Transfer Protocol (“SMTP”), etc.) over the network.

Input devices 114 can include a variety of input devices, such as, for example, a keyboard and/or mouse. User 113 can utilize input devices 114 to enter data into computer architecture 100. Display device 108 can visually present data output from computer architecture 100 on display 109. User 113 can visually perceive data displayed at display 109.

Generally, user-interface 101 is configured to function as an intermediary software layer between input devices 114 and display device 108 and other (e.g., software) components of computer architecture 100. User-interface 101 can be configured with appropriate software, such as, for example, drivers, to receive input from input devices 114 and to send output to display device 108. Thus, user-interface 101 can forward user-input to other components, such as, for example, diagram editor 102. User-interface 101 can also forward renderable image data from other components, such as, for example, rendering module 107, to display device 108.

Diagram editor 102 is configured to edit diagram data for renderable diagrams. Diagram data can indicate shape types, shape locations, end-point arrangements, and connections between shapes for shapes in a diagram. In response to user-input, diagram editor 102 can add, delete, and alter diagram data representing shapes location, shape types, end-point arrangements, and connections for shapes of a diagram. In some embodiments, a user action causes diagram editor 102 to perform a series of edits to diagram data. For example, in response to placement of a shape in a diagram, diagram editor 102 can a) edit diagram data to include the location and type of a shape, b) edit diagram data to include connections between the shape and other appropriate shapes, and c) arrangement end-points of a shape based on diagram type.

As depicted, diagram, editor 102 has access to shape types 124 and end point specialization data 123. Shape types 124 contain graphical data for a plurality of different shape types that can be included in diagrams. Virtually any shape type, including user defined shape types, can be used. Shape types can include, but are not limited to, two-dimensional geometric shapes (e.g., circles, rectangles, triangles, squares, diamonds, etc.) and three-dimensional geometric shapes (e.g., cubes, cylinders, pyramids, cones, spheres, etc.) as well as combinations thereof.

End point specialization data 123 contains data that can be used to structure an arrangement of endpoints on a shape based on the type of diagram where a shape is being placed. Virtually any diagram type, including user defined diagram types, can be used. For example, a diagram type can represent water flow for a city or a cafeteria navigation preferences for a cafeteria. Diagram types can include, but are not limited to, flow charts, organizational charts, control flow diagrams, process diagrams, graphical drawings, and schematics as well as combinations thereof.

Rendering module 107 is configured to generate interconnected visual elements from diagram data for rendering a diagram at display device 108. Connections between visual elements can be represented as a line. Rendering module 107 and diagram editor 102 can share access to diagram data 126. Rendering module 107 can use diagram data 126 as instructions for rendering visual elements to display 109. Diagram editor 102 can used diagram data 126 to infer properties for a diagram, such as, for example, diagram type.

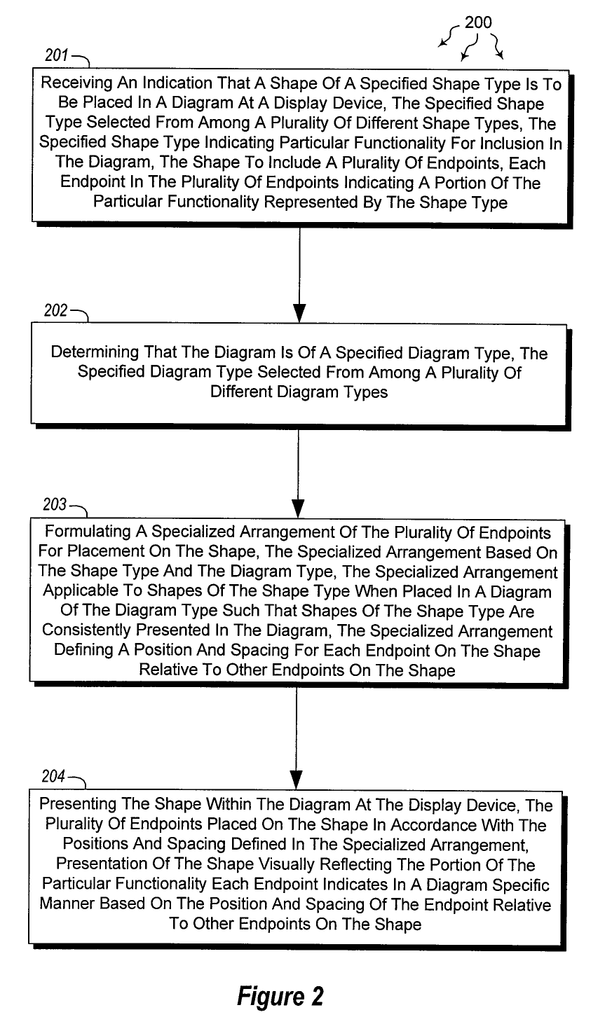

FIG. 2 illustrates a flow chart of an example method 200 for structuring an arrangement of visual endpoints in a diagram. Method 200 will be described with respect to the components and data of computer architecture 100.

Method 200 includes an act of receiving an indication that a shape of a specified shape type is to be placed in a diagram, the specified shape type selected from among a plurality of different shape types, the specified shape type indicating particular functionality for inclusion in the diagram, the shape to include a plurality of endpoints, each endpoint in the plurality of endpoints indicating a portion of the particular functionality represented by the shape type (act 201). For example, user 113 can entered shape selection input at input devices 114. User-interface 101 can receive shape selection input 122 from input devices 114. User-interface 101 can determine that shape selection input 122 is for placement of a new shape in diagram 300. As such, user-interface 101 can forward shape selection input 122 to diagram editor 102.

From shape selection input 122, diagram editor 102 can refer to shape types 124 to obtain diagram data for the selected shape type. For example, diagram editor 102 can obtain shape 127 (e.g., a rectangle representing a decision) from shape types 124

Method 200 includes an act of determining that the diagram is of a specified diagram type, the specified diagram type selected from among a plurality of different diagram types (act 202). For example, diagram editor 102 can determine that diagram 300 is of diagram type 129 (e.g., flow chart, organizational chart, a control flow diagram, process diagrams, schematics, etc.). In some embodiments, user 113 enters diagram type input using input devices 114. For example, user 113 can enter diagram type input 121 at input devices 114. User-interface 101 can receive diagram type input 121 from input devices 114. User-interface 101 can determine that diagram type input 121 relates to diagram 300. As such, user-interface 101 can forward diagram type input 121 to diagram editor 102.

Alternately, diagram editor 102 can infer diagram type 129 from diagram data 126. For example, previously placed shapes and/or connections in diagram 300 may be related to diagram type 129. Diagram editor 102 can infer diagram type 129 (for diagram 300) from previously placed shapes and/or connections represented in diagram data 126.

Method 200 includes an act of formulating a specialized arrangement of the plurality of endpoints for placement on the shape, the specialized arrangement based on the shape type and the diagram type, the specialized arrangement applicable to shapes of the shape type when placed in a diagram of the diagram type such that shapes of the shape type are consistently presented in the diagram, the specialized arrangement defining a position and spacing for each endpoint on the shape relative to other endpoints on the shape (act 203). For example, diagram editor 102 can formulate a specialized arrangement of endpoints for placement on shape 127 based on diagram type 129. The specialized arrangement can be applicable to shape 127 when placed in any diagram of diagram type 129. The specialized arrangement of endpoints defines a positions and spacing for each endpoint on shape 127 relative to other endpoints on shape 127. Accordingly, shape 127 is consistently presented in any diagram of diagram type 129.

Using the specialized arrangement of endpoints, diagram editor 102 can generated diagram specific shape 127SS.

Method 400 includes an act of presenting the shape within the diagram at the display device, the plurality of endpoints placed on the shape in accordance with the positions and spacing defined in the specialized arrangement, presentation of the shape visually reflecting the portion of the particular functionality each endpoint indicates in a diagram specific manner based on the position and spacing of the endpoint relative to other endpoints on the shape (act 204). For example, diagram editor 102 can send diagram specific shape 127SS to rendering module 107. Rendering module can convert diagram specific shape 127SS into visual elements 128 for presentation at display device 108 with diagram 300. Visual elements 128 can be rendered as shape 309 on display 109.

As depicted, shape 309 includes endpoints 319A, 319B, 319C, and 319D. Endpoints 319A, 319B, 319C, and 319D can be placed on shape 309 in accordance with the positions and spacing defined in diagram specific shape 127SS. Presentation of shape 309 can visually reflect the portion of the particular functionality each endpoint 319A, 319B, 319C, and 319D indicates in a diagram specific manner (i.e., for a diagram of diagram type 129).

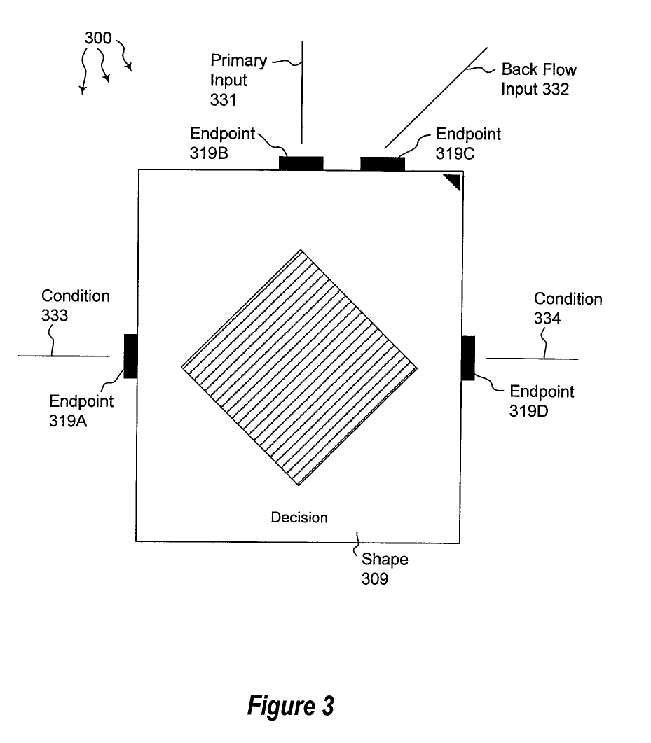

FIG. 3 illustrates an example of decision shape 309 that can be included in diagram 300. Turning to FIG. 3, Endpoint 319B can represent primary input 331, endpoint 319C can represent back flow input 332, and endpoints 319A and 319B can represent conditions 333 and 334 respectively. The arrangement of endpoints 319A-319D can be an arrangement to reflect their function for a diagram of diagram type 129. For example, in control flow base diagramming, conventions can indicate If-Then conditions coming out of the left and right of a shape. Backflow is a less common connection, but is important to call out. Placing backflow 332 at the top of shape 309 but to the right of primary input 331 conveys its meaning in a manner that facilitates a consistent “flow” of information within diagram 300. That is, in general, information flows input the top of a decision shape and out of the sides of the decisions shape.

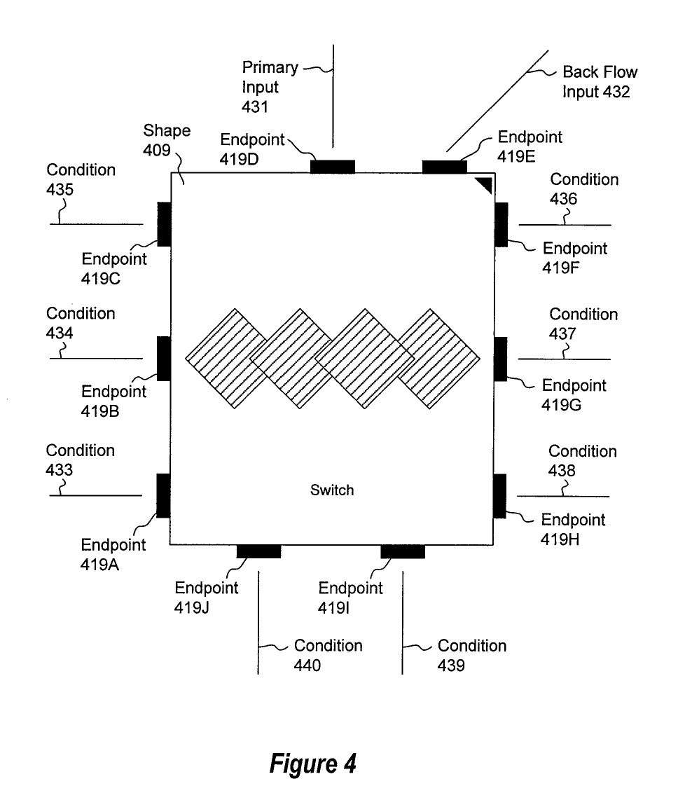

FIG. 4 illustrates an example of a switch shape 409 that can also be included in diagram 300. Turning now to FIG. 4, switch shape 409 includes endpoints 419A-419J. Endpoint 419D represents primary input 431, endpoint 319E represents back flow input 432, and endpoints 419A-419C represent conditions 433-435 respectively, and endpoints 419F-419J represent conditions 436-440 respectively. Although switch shape 409 is more complex than decisions shape 309, the structure of endpoints (e.g., for diagram type 129) is maintained. For example, similar to decision shape 309, primary and back flow inputs are located at the top of switch shape 409. Accordingly, the shape is easier to understand relative to decision shape 309. Further, an entire diagram can be made easier to read, update, and discuss. In some embodiments, this consistency facilitates a “learn once, apply everywhere” user experience on a per diagram type basis.

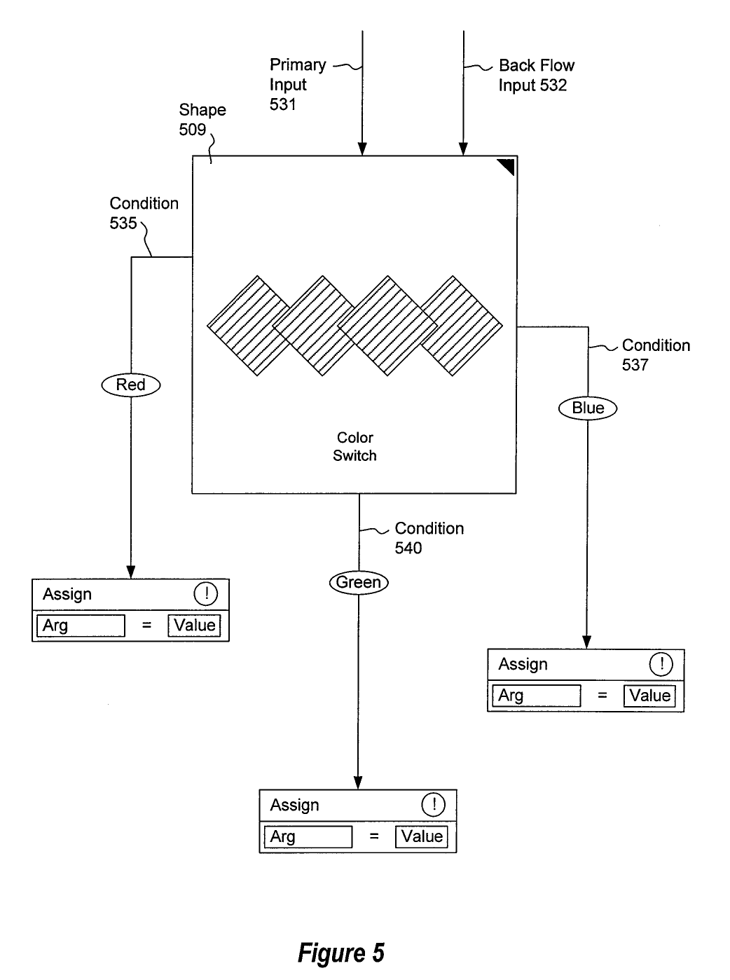

FIG. 5 illustrates an example of a color switch shape 509 that can be included in diagram 300. Using colors, users can be more efficiently distinguish which inputs are about control flow versus information input and further which inputs are primary versus back flow. For example, using colors, conditions 535, 537, and 540 can be further distinguished from primary and back flow inputs 531 and 532.

It should be understand that the depicted shapes, as well as a variety of other shape types can be connected to one another to form arbitrarily complex diagrams. For example, condition 333 can be connected to primary input 431 within a diagram. Other connections can be made between other endpoints of decision shape 309 and switch shape 409 and the endpoints of other shapes.

Accordingly, embodiments of the invention can be used to present endpoints in a way such that they are consistent across a domain (diagram type). That is, common patterns and common endpoint arrangements for shapes can be adopted. This commonality increases consistency across shapes, provides users with a more structured approach to connection creation, and increases diagram readable by different users.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed:

1. At a computer system including a display device, a method for presenting a shape at the display device, the method comprising:
an act of receiving an indication that a shape of a specified shape type is to be placed in a diagram, the specified shape type selected from among a plurality of different shape types, the specified shape type indicating particular functionality for inclusion in the diagram, the shape to include a plurality of endpoints, each endpoint in the plurality of endpoints indicating a portion of the particular functionality represented by the shape type;
an act of determining that the diagram is of a specified diagram type, the specified diagram type selected from among a plurality of different diagram types;
an act of formulating a specialized arrangement of the plurality of endpoints for placement on the shape, the specialized arrangement based on the shape type and the diagram type, the specialized arrangement applicable to shapes of the shape type when placed in a diagram of the diagram type such that shapes of the shape type are consistently presented in the diagram, the specialized arrangement defining a position and spacing for each endpoint on the shape relative to other endpoints on the shape; and
an act of presenting the shape within the diagram at the display device, the plurality of endpoints placed on the shape in accordance with the positions and spacing defined in the specialized arrangement, presentation of the shape visually reflecting the portion of the particular functionality each endpoint indicates in a diagram specific manner based on the position and spacing of the endpoint relative to other endpoints on the shape.

2. The method as recited in claim 1, wherein the act of receiving an indication that a shape of a specified shape type is to be placed in a diagram comprises an act of receiving shape selection input at an input device.

3. The method as recited in claim 1, wherein the act of receiving an indication that a shape of a specified shape type is to be placed in a diagram comprises an act of determining that a shape, selected from among a plurality of two-dimensional shape types and a plurality of three-dimensional shape types, is to be placed in the diagram.

4. The method as recited in claim 1, wherein the act of determining that the diagram is of a specified diagram type comprises an act of receiving diagram type input at an input device.

5. The method as recited in claim 1, wherein the act of determining that the diagram is of a specified diagram type comprises an act of inferring the specified diagram type from previously placed shapes and connections in the diagram.

6. The method as recited in claim 1, wherein the act of determining that the diagram is of a specified diagram type comprises an act of determining that the diagram is one of: a flow chart, an organizational chart, a control flow diagram, a process diagram, and a schematic.

7. The method as recited in claim 1, wherein an act of formulating a specialized arrangement of the plurality of endpoints for placement on the shape comprises an act of formulating a specialized arrangement of the plurality of endpoints for placement on a shape, the shape selected from among a plurality of two-dimensional shape types and a plurality of three-dimensional shape types.

8. The method as recited in claim 1, wherein an act of formulating a specialized arrangement of the plurality of endpoints for placement on the shape comprises an act of formulating a specialized arrangement of the plurality of endpoints representing the functionality of a decision.

9. The method as recited in claim 1, wherein an act of formulating a specialized arrangement of the plurality of endpoints for placement on the shape comprises an act of formulating a specialized arrangement of the plurality of endpoints representing the functionality of a switch.

10. The method as recited in claim 1, wherein the act of presenting the shape within the diagram comprises an act of presenting the shape in a manner consistent with other shapes already placed in the diagram based on the diagram type.

11. A computer program product for use at a computer system, the computer program for implementing a method for presenting a shape at the display device, the computer program product comprising one or more computer storage media having stored there on computer-executable instructions that, when executed at a processor, cause the computer system to perform the method, including the following:
receive an indication that a shape of a specified shape type is to be placed in a diagram, the specified shape type selected from among a plurality of different shape types, the specified shape type indicating particular functionality for inclusion in the diagram, the shape to include a plurality of endpoints, each endpoint in the plurality of endpoints indicating a portion of the particular functionality represented by the shape type;
determine that the diagram is of a specified diagram type, the specified diagram type selected from among a plurality of different diagram types;
formulate a specialized arrangement of the plurality of endpoints for placement on the shape, the specialized arrangement based on the shape type and the diagram type, the specialized arrangement applicable to shapes of the shape type when placed in a diagram of the diagram type such that shapes of the shape type are consistently presented in the diagram, the specialized arrangement defining a position and spacing for each endpoint on the shape relative to other endpoints on the shape; and
present the shape within the diagram at the display device, the plurality of endpoints placed on the shape in accordance with the positions and spacing defined in the specialized arrangement, presentation of the shape visually reflecting the portion of the particular functionality each endpoint indicates in a diagram specific manner based on the position and spacing of the endpoint relative to other endpoints on the shape.

12. The computer program product as recited in claim 11, wherein computer-executable instructions that when executed cause the computer system to receive an indication that a shape of a specified shape type is to be placed in a diagram comprise computer-executable instructions that when executed cause the computer system to an receive shape selection input at an input device.

13. The computer program product as recited in claim 11, wherein computer-executable instructions that when executed cause the computer system to receive an indication that a shape of a specified shape type is to be placed in a diagram comprise computer-executable instructions that when executed cause the computer system to determine that a shape selected from among a circle, rectangle, square, triangle, and diamond is to be placed in the diagram.

14. The computer program product as recited in claim 11, wherein computer-executable instructions that when executed cause the computer system to determine that the diagram is of a specified diagram type comprise computer-executable instructions that when executed cause the computer system to receiving diagram type input at an input device.

15. The computer program product as recited in claim 1, wherein computer-executable instructions that when executed cause the computer system to determine that the diagram is of a specified diagram type comprise computer-executable instructions that when executed cause the computer system to infer the specified diagram type from previously placed shapes and connections in the diagram.

16. The computer program product as recited in claim 11, wherein computer-executable instructions that when executed cause the computer system to determine that the diagram is of a specified diagram type comprise computer-executable instructions that when executed cause the computer system to determine that the diagram is one of: a flow chart, an organizational chart, a control flow diagram, a process diagram, and a schematic.

17. The computer program product as recited in claim 11, wherein computer-executable instructions that when executed cause the computer system to formulate a specialized arrangement of the plurality of endpoints for placement on the shape comprise computer-executable instructions that when executed cause the computer system to formulate a specialized arrangement of the plurality of endpoints for placement on a shape, the shape selected from among: a circle, rectangle, square, triangle, and diamond.

18. The computer program product as recited in claim 11, wherein computer-executable instructions that when executed cause the computer system to formulate a specialized arrangement of the plurality of endpoints for placement on the shape comprise computer-executable instructions that when executed cause the computer system to formulate a specialized arrangement of the plurality of endpoints representing the functionality of one of: a decision and a switch.

19. The computer program product as recited in claim 11, wherein computer-executable instructions that when executed cause the computer system to present the shape within the diagram comprise computer-executable instructions that when executed cause the computer system to presenting the shape in a manner consistent with other shapes already placed in the diagram based on the diagram type.

20. A computer system, the computer system including:
one or more processors;
system memory;
a display device, the display device configured to present visual elements for viewing; and
one or more computer-readable media having stored there one computer-executable instructions representing a user-interface, a diagram editor, and a rendering module, wherein the user-interface is configured to:
receive user input, including shape selection input, from input devices;
forward the user input, including shape selection input, to appropriate modules for processing;
receive visual elements from the rendering module, the rendering elements representing diagram data for inclusion in a diagram; and
forward the received visual elements to the display device for presentation;
wherein the diagram editor is configured to:
receive shape selection input indicating that a shape of a specified shape type is to be placed in a diagram, the specified shape type selected from among a plurality of different shape types, the specified shape type indicating particular functionality for inclusion in the diagram, the shape to include a plurality of endpoints, each endpoint in the plurality of endpoints indicating a portion of the particular functionality represented by the shape type;
determine that the diagram is of a specified diagram type, the specified diagram type selected from among a plurality of different diagram types;
formulate a specialized arrangement of the plurality of endpoints for placement on the shape, the specialized arrangement based on the shape type and the diagram type, the specialized arrangement applicable to shapes of the shape type when placed in a diagram of the diagram type such that shapes are consistently presented in the diagram, the specialized arrangement defining a position and spacing for each endpoint on the shape relative to other endpoints on the shape; and
send data for a diagram specific shape to the rendering module, the data indicated that the diagram specific shape is to be rendered using the specialized arrangement of endpoints;
wherein the rendering module is configured to:
receive data for the diagram specific shape from the diagram editor; and
convert the data to visual elements.
